(19) United States
(12) Patent Application Publication
(10) Pub. No.: US 2014/0207576 A1
(43) Pub. Date: Jul. 24, 2014

(54) DIGITAL ADVERTISING CELLULAR DISPLAY SYSTEM

(71) Applicant: Brian B. Walker, Big Lake, MN (US)

(72) Inventor: Brian B. Walker, Big Lake, MN (US)

(21) Appl. No.: 13/747,687

(22) Filed: Jan. 23, 2013

(51) Int. Cl. G06Q 30/02

(52) U.S. Cl. CPC G06Q 30/0267
USPC 705/14.64

(57) ABSTRACT

A digital advertising cellular display system comprising a retail outlet having at least one location for displaying goods and services for purchase, at least one electronic display means located proximal the location for displaying goods and services with electronic display means displaying consumer information images, videos, and audios therefrom, a central processing unit located in each of said electronic display means, and at least one offsite control center in wireless communication with the electronic display means for transferring control information and product and services advertisement and product and services information between the offsite control center and the electronic display means.

### CROSS REFERENCE TO RELATED APPLICATIONS

This application claims priority to currently pending U.S. Provisional Application Ser. No. 61/632,223; filed Jan. 23, 2012; titled DIGITAL ADVERTISING CELLULAR DISPLAY SYSTEM.

### FIELD OF THE INVENTION

This invention relates to product and services advertisement and product and services information and more specifically to a digital advertising cellular display system.

### STATEMENT REGARDING FEDERALLY SPONSORED RESEARCH OR DEVELOPMENT

None

### REFERENCE TO A MICROFICHE APPENDIX

None

### SUMMARY OF THE INVENTION

The present invention comprises a digital advertising cellular display system that includes a retail outlet having at least one location for displaying goods and services for purchase and at least one electronic display means located proximal the location for displaying goods and services with the electronic display means displaying consumer information images, videos, and audios therefrom. The electronic display means includes a central processing unit located therein, a memory storage unit located therein and connected to the central processing unit, and a wireless data transmission device located therein and connected to the central processing unit. The digital advertising cellular display system also includes at least one offsite control center in wireless communication with the wireless data transmission device for transferring control information and product and services advertisement and product and services information between said offsite control center and said wireless data transmission device.

### BRIEF DESCRIPTION OF THE DRAWINGS

FIG. 1 shows a schematic of an embodiment of my digital advertising cellular display system;

FIG. 2 shows a schematic of an embodiment of a electronic display means of FIG. 1; and

FIG. 3 shows a schematic of an alternative embodiment of my digital advertising cellular display system.

### DESCRIPTION OF THE PREFERRED EMBODIMENT

In the field of providing consumers information about products, a large number of methods and devices exist to convey information about potential purchases.

Unfortunately, most of these devices and methods are physical in nature, such as cards and placards placed around products.

One of the drawbacks of physical methods and devices to convey information to potential consumers is the static nature of the devices. Since price changes, availability changes, comparison information changes, all must be done manually, and at each physical location where a physical information device exists. The process of changing these devices to update current conditions is time consuming and laborious. If a retailer, producer, manufacturer or other trader of goods has outlets in multiple locations this process of changing physical information devices can become extremely laborious. The aforementioned process of changing physical information is also prone to the introduction of errors due to the volume of information being changed. That is, information at one retail outlet may be different than at another retail outlet as multiple individuals are likely to be involved changing the physical information. A further disadvantage is that the consumer often lacks control of the information being displayed.

It is a further object of this invention to create an information system wherein the information that the system conveys can be changed rapidly, uniformly, and globally, to allow an information manager easy and quick access to know what his or her customers are viewing. It is a further object of this invention to create an information projection system wherein the images projected can be altered from a remote location. It is a further object of this invention to create an information system wherein the images and information conveyed to consumer can be specifically tailored and or modified for that specific consumer on demand.

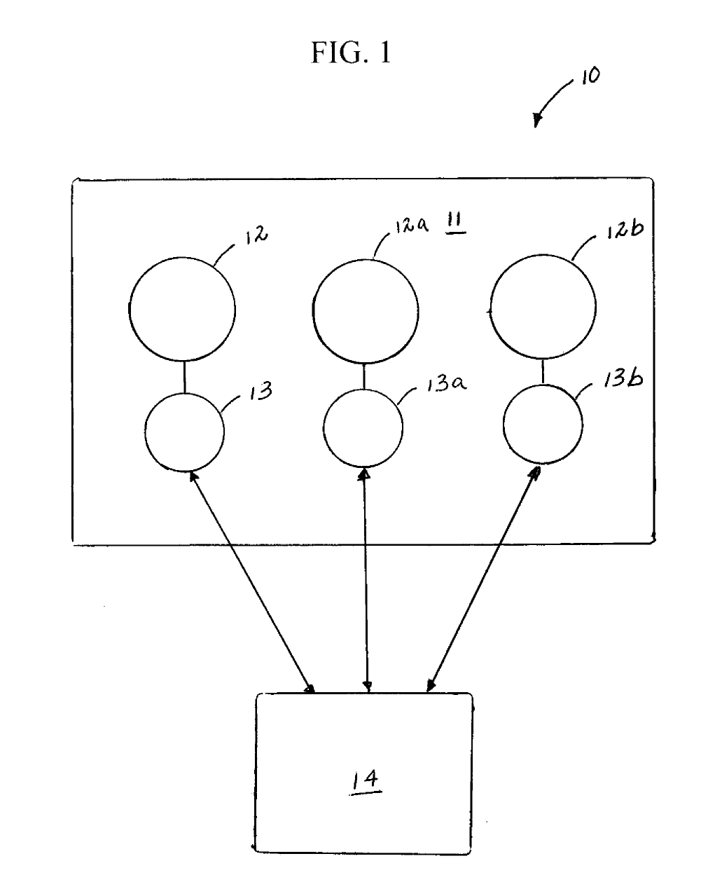

FIG. 1 shows a schematic of an embodiment of my digital advertising cellular display system 10. Reference numeral 11 indicates a retail outlet that may be up to 40,000 square feet or larger having a plurality of locations for displaying goods and services for purchase 12, 12a, and 12b. Located proximal each of the locations for displaying goods and services for purchase 12,12a, 12b is an electronic display means 13,13a, 13b for displaying and communicating consumer products and product attributes on behalf of a brand and/or retailer and services information images, videos, and audios about the products and/or services located nearby. The electronic display means 13, 13a, 13b are shown in wireless communication with an off-site control center 14 to enable the transmittance of control information and real-time product and services advertisement and product and services information between the offsite control center 14 and the electronic display means 13, 13a, 13b.

It is noted that the offsite control center 14 may control information and real-time product and services advertisement and product and services information of the electronic display means 13, 13a, 13b from as few as one retail location to a chain of retail locations. Having one offsite control center 14 controlling information of the electronic display means 13, 13a, 13b of a chain of retail locations provides the benefit of consistency of information among all of the retail change sites while greatly reducing the labor and employee time spent in changing information compared to previous physical methods and static devices used to convey information to potential consumers.

Electronic display means 13, 13a, 13b may each comprise an individual screen or a component of a larger display systems that includes a plurality of LCD/LED display screens built into case headers, a plurality of free standing interactive kiosks, countertop displays fixtures and temporary and permanent displays screens.

FIG. 1 shows digital advertising cellular display system 10 in which single offsite control center 14 is in wireless communication with all of electronic display means 13, 13a, 13b for transferring control information and product and services advertisement and product and services information between single offsite control center 14 and each of electronic display means 13,13a, 13b.

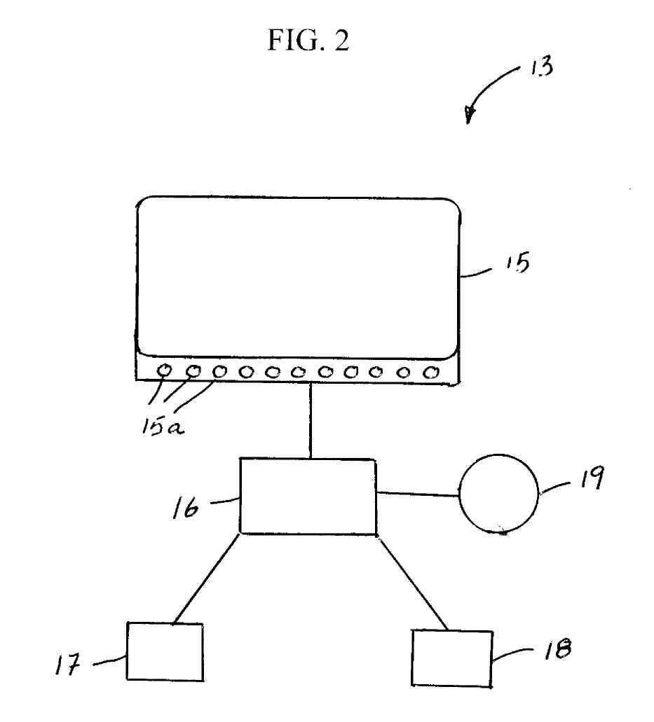

FIG. 2 shows a schematic of an embodiment of the electronic display means 13 of FIG. 1. As shown electronic display means 13 includes a LCD/LED display screen 15. Although not required. LCD/LED display screen 15 includes touch screen control and push buttons 15a addressability by consumers and retailers to provide for interactivity between a potential purchaser and LCD/LED display screen 15. As an alternative to push buttons 15a. LCD/LED display screen 15 may comprise a touch response screen.

As a secondary option electronic display means 13 may also include a method of communication by consumers and retailers through electronic display mean 13 and the consumer's mobile devices including but not limited to cellular phones and tablets. The communication between electronic display mean 13 and the consumer's mobile devices may include the share of information at distances of less than 4 centimeters with communication speed of 424 kbps to limit access of consumer information to provide for added security.

The interactivity between the potential purchaser and LCD/LED display screen 15 may include the displaying of potential purchaser's specifically requested content including contents that are uploaded on demand via the Internet, independently by electronic display means 13 if desired, and immediately played or displayed on LCD/LED display screen 15 for the potential purchaser.

As part of the interactivity between the potential purchaser and LCD/LED display screen 15 a retail relationship may be established with the potential purchaser by providing the potential purchaser with an opt-in feature during which information may be exchanged between the potential purchaser and the electronic display means 13 via LCD/LED display screen 15. The exchange of information may include but is not limited to the potential purchaser providing the electronic display means 13 with product preferences and personal information such as email address(es), home address(es), and phone numbers. The exchange of information enables the retailer to use the potential purchaser's data for present and future use such as delivering certain types of promotional retail benefits and or value to the potential purchaser either at the current time or site purchasing and/or in the future to promote sales.

As a supplement to the above, multiple interactivity between the potential purchaser and LCD/LED display screen 15 for different products may result in the building of data on the specific potential purchaser relating to the type of food and products and the volume of food and products that the potential purchaser uses and consumes and other retail habits of that specific potential purchaser. The data volume of data collected, which if processed by the retailer, may result in the formation of a retail avatar or retail profile of the specific potential purchaser based on the potential purchaser's email address, home address, and/or phone number.

Electronic display means 13 also includes a central processing unit 16 located therein for processing information, a memory storage unit such as flash memory storage 17 located in electronic display means 13 and connected to central processing unit 16, and a wireless data transmission device such as a 3G/4G/4G LTE cellular phone chip 18 also located in electronic display means 13 and connected to central processing unit 16 for providing wireless communication with an off-site control center 14 and allowing access to the internet for data transfer. An example of a central processing unit that is currently available would be the Snapdragon™ S4 Processors manufactured by Qualcomm®, a corporation headquartered in San Diego. Calif., USA.

Electronic display means 13 may also include the implementation and use of other mobile communication technologies including but not limited to NFC (Near Field Communication). SMS, packet-based connections, Bluetooth, Bluetooth Low Energy, RFID, GPS and a blending of other emerging technologies.

Although not require electronic display means 13 is shown also including a motion-sensing device 19 connected to central processing unit 16 for allowing the display of content when consumers are nearby while maintaining the display of content on standby when consumers are distal to electronic display means 13 in order to not only reduce power consumption but also to provide for a focused message(s) to the consumer so that the consumer is less likely to be overwhelmed by a plurality of messages in the consumer's distal visual line of sight.

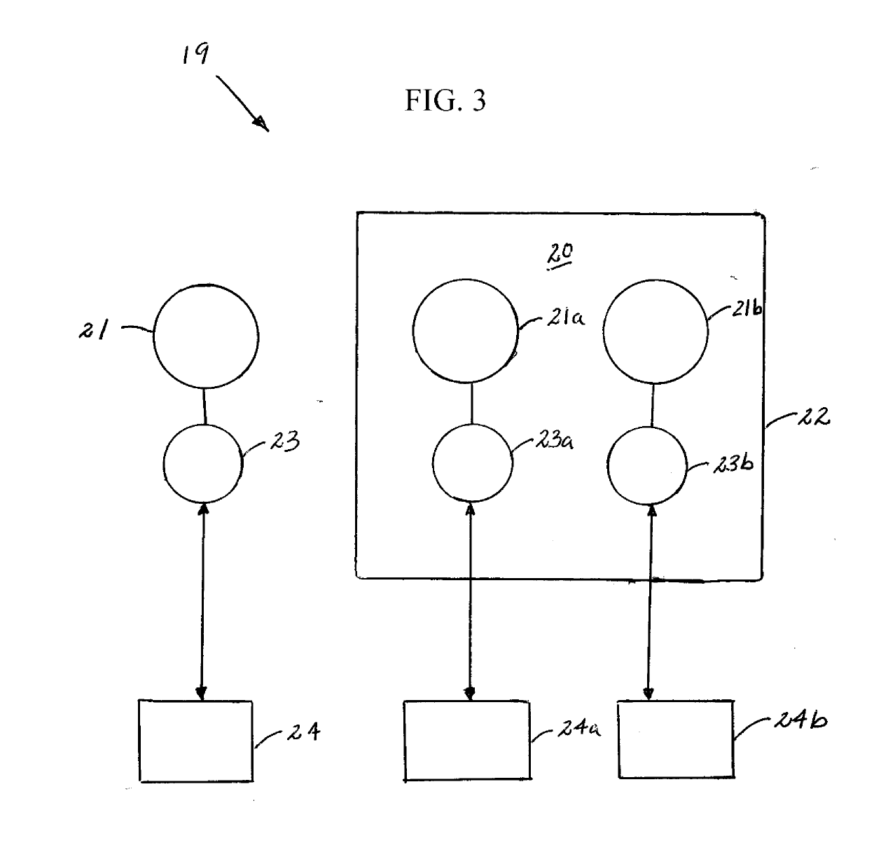

FIG. 3 shows a schematic of an alternative embodiment of my digital advertising cellular display system 19 having similar component to digital advertising cellular display system 10 in that digital advertising cellular display system 19 includes a retail outlet 20 having a first location for displaying goods and services for purchase 21, a second location for displaying goods and services for purchase 21a, and a third location for displaying goods and services for purchase 21b. Located proximal first location 21 is a first electronic display means 23, located proximal second location 21a is a second electronic display means 23a, and located proximal third location 21b is a third electronic display means 23b.

Note however that unlike digital advertising cellular display system 10, second location for displaying goods and services for purchase 21a, and third location for displaying goods and services for purchase 21b are both located within housing or building 22 while first location for displaying goods and services for purchase 21 is located outdoors.

In additional, unlike digital advertising cellular display system 10, each of the electronic display means 23, 23a, 23b are in independent wireless communication with a corresponding offsite control center. More specifically, first electronic display means 23 is shown in independent wireless communication with a first offsite control center 24, second electronic display means 23a is shown in independent wireless communication with a second offsite control center 24a third electronic display means 23b is shown in independent wireless communication with a third offsite control center 24b for transferring control information and product and services advertisement and product and services information between the electronic display mean 23, 23a, 23b and their corresponding offsite control centers 24, 24a, 24b to provide for interactivity between a potential purchaser and said electronic display. The phrase independent wireless communication as referred to the wireless communication between each of the electronic display mean 23, 23a, 23b and their corresponding offsite control centers 24, 24a, 24b is understood as each of the electronic display mean 23, 23a, 23b and their corresponding offsite control centers 24, 24a, 24b being wireless connected and in communication by a unique wireless frequency or the like that may only be received and transmitted by the electronic display mean 23, 23a, 23b and their corresponding offsite control centers 24, 24a, 24b, similar to a wireless connection between two cellular phones, to prevent cross-over in communication between a electronic display mean and a non-corresponding offsite control centers.

I claim:

1. A digital advertising cellular display system comprising:
a retail outlet having at least one location for displaying goods and services for purchase;
at least one electronic display means located proximal said location for displaying goods and services, said electronic display means displaying consumer information images, videos, and audios therefrom:
a central processing unit located in each of said electronic display means;
a memory storage unit located in each of said electronic display means, said memory storage connected to said central processing unit;
a wireless data transmission device located in each of said electronic display means and connected to said central processing unit; and
at least one offsite control center in wireless communication with said wireless data transmission device for transferring control information and product and services advertisement and product and services information between said offsite control center and said wireless data transmission device.

2. The digital advertising cellular display system of claim 1 wherein said wireless data transmission device comprises a 3G/4G/4G LIE cellular phone chip for allowing access to the Internet for data transfer.

3. The digital advertising cellular display system of claim 1 wherein said at least one electronic display means comprises a component of a larger display systems that includes a plurality of LCD/LED display screens built into case headers, a plurality of free standing interactive kiosks, countertop displays fixtures and temporary and permanent displays screens.

4. The digital advertising cellular display system of claim 1 wherein said at least one location for displaying goods and services for purchase is located both indoors and outdoors.

5. The digital advertising cellular display system of claim 1 including a motion-sensing device allowing the display of content when consumers are nearby to reduce power consumption.

6. The digital advertising cellular display system of claim 1 wherein said memory storage unit comprises a flash memory storage.

7. The digital advertising cellular display system of claim 1 wherein said at least one electronic display means includes push button and touch screen addressable by consumers and retailers.

8. The digital advertising cellular display system of claim 1 wherein said at least one electronic display means includes a device providing for communication between said at least one electronic display means and a consumer's mobile device.

9. A digital advertising cellular display system comprising:
a retail outlet having a plurality of locations for displaying goods and services for purchase;
at least one electronic display means located proximal each of said location for displaying goods and services, said electronic display means displaying consumer information images, videos, and audios therefrom;
a central processing unit located in each of said electronic display means;
a memory storage unit located in each of said electronic display means, said memory storage connected to said central processing unit;
a wireless data transmission device located in each of said electronic display means and connected to said central processing unit; and
an offsite control center in wireless communication with all of said wireless data transmission devices for transferring control information and product and services advertisement and product and services information between said offsite control center and said electronic display means.

10. The digital advertising cellular display system of claim 9 wherein said wireless data transmission device comprises a 3G/4G/4G LTE cellular phone chip for allowing access to the interne for data transfer.

11. The digital advertising cellular display system of claim 10 wherein said at least one electronic display means comprises a component of a larger display systems that includes a plurality of LCD/LED display screens built into case headers, a plurality of free standing interactive kiosks, countertop displays fixtures and temporary and permanent displays screens.

12. The digital advertising cellular display system of claim 11 wherein said location for displaying goods and services is located both indoors and outdoors.

13. The digital advertising cellular display system of claim 12 including a motion-sensing device allowing the display of content when consumers are nearby to reduce power consumption.

14. The digital advertising cellular display system of claim 13 wherein said memory storage unit comprises a flash memory storage.

15. The digital advertising cellular display system of claim 14 wherein said at least one electronic display means includes push button and touch screen addressable by consumers and retailers.

16. The digital advertising cellular display system of claim 15 wherein said at least one electronic display means includes a device providing for communication between said at least one electronic display means and a consumer's mobile device.

17. A digital advertising cellular display system comprising:
a retail outlet having a plurality of locations for displaying goods and services for purchase;
at least one electronic display means located proximal each of said location for displaying goods and services, said electronic display means displaying consumer information images, videos, and audios therefrom;
a central processing unit located in each of said electronic display means;
a memory storage unit located in each of said electronic display means, said memory storage connected to said central processing unit;
a wireless data transmission device located in each of said electronic display means and connected to said central processing unit; and
a plurality of offsite control centers with each offsite control center in independent wireless communication with a corresponding wireless data transmission device for transferring control information and product and services advertisement and product and services information between said offsite control center and a corresponding electronic display mean to provide for interactivity between a potential purchaser and said electronic display.

18. The digital advertising cellular display system of claim 17 wherein said at least one electronic display means comprises a component of a larger display systems that includes a plurality of LCD/LED display screens built into case headers, a plurality of free standing interactive kiosks, countertop displays fixtures and temporary and permanent displays screens and wherein said wireless data transmission device comprises a 3G/4G/4G LTE cellular phone chip for allowing access to the internet for data transfer.

19. The digital advertising cellular display system of claim 18 wherein said at least one location for displaying goods and services for purchase is located both indoors and outdoors.

20. The digital advertising cellular display system of claim 19 wherein said at least one electronic display means includes push button and touch screen addressable by consumers and retailers and a device providing for communication between said at least one electronic display means and a consumer's mobile device.
